(19) United States
(12) Patent Application Publication
(10) Pub. No.: US 2025/0224223 A1
(43) Pub. Date: Jul. 10, 2025

(54) COMPARATIVE CALIPER AND METHOD FOR MEASURING USING THE SAME

(71) Applicant: Guilin Gemred Sensor Technology Co., Ltd., Guilin (CN)

(72) Inventors: Bingheng LI, Guilin (CN); Guanglu YANG, Guilin (CN); Xiamei WEN, Guilin (CN); Mengying SHI, Guilin (CN)

(21) Appl. No.: 19/002,597

(22) Filed: Dec. 26, 2024

(30) Foreign Application Priority Data
Jan. 5, 2024 (CN) 202410018935.6

(51) Int. Cl. G01B 7/02

(52) U.S. Cl. CPC G01B 7/02; G01B 2210/44

(57) ABSTRACT

A comparative caliper, including: a signal processing module; an input device; and a measurement device. The signal processing module is connected to the input device and the measurement device; the input device is configured to set a reference value and tolerance limits; the measurement device is configured to measure a relative displacement between two points on an object, and then relays the relative displacement to the signal processing module; and the signal processing module is configured to store data and perform calculations.

### CROSS-REFERENCE TO RELATED APPLICATIONS

Pursuant to 35 U.S.C. § 119 and the Paris Convention Treaty, this application claims foreign priority to Chinese Patent Application No. 202410018935.6 filed Jan. 5, 2024, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of measuring tools, and more particularly, to a comparative caliper and a method for measuring using the same.

Length measurement aims to obtain precise dimension by comparing a target dimension with a standardized measurement scale. The standardized measurement scale is provided by reference tools, such as calibrated rulers, gauge blocks, optical gratings, inductive synchronizers, or laser interferometers. A fundamental principle in length measurement is the Abbe Principle, that is, for accurate measurement, the axis of the measured length must align with the axis of the reading scale.

When the two axes are not aligned, angular errors, also known as Abbe errors, are produced in the measurement. To minimize the Abbe errors, two main approaches are used: 1. The guide rail slides without any angular movement. 2. A more effective approach to counteract Abbe errors involves calculating the influence of angular displacement and offsetting the influence using actual angular movement data.

Manufacturing and installation errors of calipers causes skewing in the direction of travel, so it is not possible to completely avoid the angular movement. To reduce Abbe error in caliper measurements, it is necessary to develop a method that automatically corrects the Abbe error during the measurement process.

### SUMMARY

To solve the aforesaid problems, one objective of the disclosure is to provide a comparative caliper.

The comparative caliper comprises a signal processing module, an input device, a measurement device. The signal processing module is connected to the input device and the measurement device.

The input device is configured to set a reference value and tolerance limits.

The measurement device is configured to measure a relative displacement between two points on an object, and then relays the relative displacement to the signal processing module.

The signal processing module is configured to store data and perform calculations.

The signal processing module comprises a memory and a microcontroller. The microcontroller is connected to the input device and the measurement device. The memory is connected to the microcontroller.

The microcontroller is configured to process signals received from the capacitive grating sensor.

The memory is configured to temporarily storage data during a calculation process and stores a final calculation result.

The measurement device comprises a capacitive grating sensor, a fixed scale, and a sliding scale. The capacitive grating sensor is disposed on the fixed scale and the sliding scale. The capacitive grating sensor is connected to the microcontroller.

The capacitive grating sensor is configured to detect the relative displacement between the fixed scale and the sliding scale, and then relays the relative displacement to the signal processing module. The capacitive grating sensor is further configured to set characters for the reference value and tolerance limits, and transmits the characters to the memory.

The comparative caliper further comprises a display device connected to the signal processing module.

The display device is configured to display the relative displacement, the tolerance limits, the reference value, and a comparative judgement result.

Another objective of the disclosure is to provide a method for measuring using the comparative caliper, the method comprising:
1. configuring, via the input device, the reference value and tolerance limits;
2. moving the sliding scale to a measurement point, where the sliding scale is in contact with the object being measured, thereby obtaining a measurement value;
3. retrieving, using the signal processing module, the reference value and tolerance limits for the measurement point; and displaying the reference value and tolerance limits on the display device; and
4. comparing, using the signal processing module, the measurement value with the corresponding reference value and tolerance limits; and determining a comparison result whether the measurement value is within the tolerance limits.

In the disclosure, the user operates the input device to enter the setup mode. In the setup mode, each group of reference value and tolerance limits is set in sequence. After setting one group of the reference value and tolerance limits, the user can save and exit the setup mode or continue to set the next group of the reference value and tolerance limits. The comparative caliper allows the user to store N groups of the reference value and tolerance limits. When performing a measurement, the comparative caliper automatically identifies a correct group of the reference value and tolerance limits for the measurement point. The identification process works as follows: When the comparative caliper takes a measurement, the reading is recorded as a measurement value x. Additionally, the absolute value of the measurement is recorded as a. Each reference value is assigned with a unique identifier n, and each reference value is denoted x(n). The signal processing module identifies which reference value to use, and calculates an absolute difference |a−x(n)| between the measurement absolute value a and the identified reference value. The signal processing module loops through all the reference values n and finds one reference value that gives the smallest absolute difference |a−x(n)|. The identifier n of the identified reference value is recorded. The signal processing module retrieves the corresponding reference value and tolerance limits from the memory. The corresponding reference value and tolerance limits are displayed on the display device for the user to see. The signal processing module compares the measurement value x with the corresponding reference value x(n) and check if the difference falls within an acceptable tolerance range. Specifically, the measurement value x is marked as “qualified” if the measurement value x is less than or equal to the sum of the identified reference value x(n) and the upper tolerance limit, and is greater than or equal to the sum of the identified reference value x(n) and the lower tolerance limit. Otherwise, the current measurement value x is marked as “unqualified”. The identification process simplifies the measurement process by allowing users to measure any group of the reference values in any order without having to memorize or select specific settings manually. By automating both the group identification and Abbe error compensation, the comparative caliper enhances measurement efficiency and accuracy.

### BRIEF DESCRIPTION OF THE DRAWINGS

FIG. 1 is a block diagram showing the working principle of a comparative caliper according to Example 1 of the disclosure;

FIG. 2 is a schematic view of a display device according to Example 1 of the disclosure; and

FIG. 3 is a flowchart of the steps in a method for measuring a comparative caliper according to Example 2 of the disclosure.

In the drawings, the following reference numbers are used: 101. Signal processing module; 102. Input device; 103. Measuring device; 104. Capacitive grating sensor; 105. Fixed scale; 106. Sliding scale; 107. Display device; 108. Memory; and 109. Microcontroller.

### DETAILED DESCRIPTION

To further illustrate the disclosure, embodiments detailing a comparative caliper and a method for measuring using the same are described below. It should be noted that the following embodiments are intended to describe and not to limit the disclosure.

### EXAMPLE 1

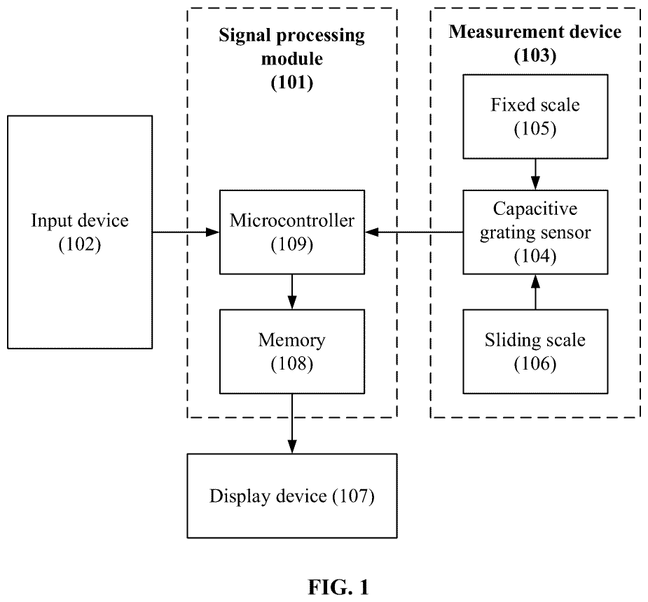

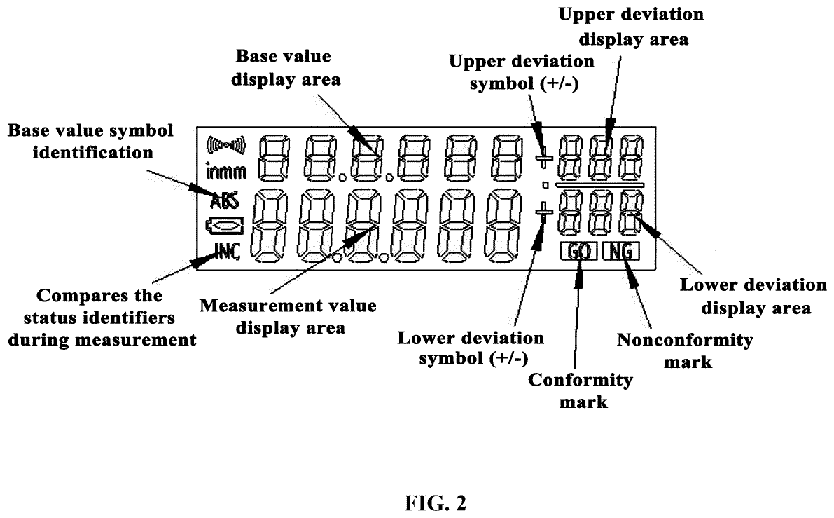

FIG. 1 is a block diagram showing the working principle of a comparative caliper according to Example 1 of the disclosure. FIG. 2 is a schematic view of a display device according to Example 1 of the disclosure. As shown in FIGS. 1 and 2, a comparative caliper comprises a signal processing module 101, an input device 102, a measurement device 103, and a display device 107. The measurement device 103 comprises a capacitive grating sensor 104, a fixed scale 105, and a sliding scale 106. The signal processing module 101 comprises a memory 108 and a microprocessor 109.

The signal processing module 101 is connected to the input device 102 and the measurement device 103.

The input device 102 is configured to set the reference value and tolerance limits.

The measurement device 103 is configured to measure a relative displacement between two points on an object, and then relays the relative displacement to the signal processing module 108.

The signal processing module 101 is configured to store data and perform calculations.

The microprocessor 109 is connected to the input device 102 and the measurement device 103. The microcontroller 109 is connected to the capacitive grating sensor 104.

The microprocessor 109 is connected to the memory 108.

The microprocessor 109 is configured to process the signals received from the capacitive grating sensor 104.

The memory 108 is configured to temporarily storage the data and the calculations.

The capacitive grating sensor 104 is disposed on both the fixed scale 105 and the sliding scale 106.

The capacitive grating sensor 104 is configured to detect the relative displacement between the fixed scale and the sliding scale, and then relays the relative displacement to the microprocessor 109. The capacitive grating sensor 104 is further configured to set characters for the reference value and tolerance limits, and transmit the characters to the memory 108.

The display device 107 is connected to the signal processing module 101.

The display device 107 is configured to display the relative displacement, the reference value, and the tolerance limits.

Inherent errors in the manufacturing and installation of calipers cause slight deviations in the movement direction of the caliper scales, leading to angular misalignments. The angular misalignments introduce angular movement that is difficult to fully eliminate. The inherent error, often referred to as Abbe error, can be reduced as follows:

A set of gauge blocks is combined to match a reference dimension of the object to be measured. The comparative caliper is used to measure the set of gauge blocks. During the measurement, the Abbe error is captured at the reference point. Using the gauge block measurement, the comparative caliper is then zeroed to account for the Abbe error. Because the Abbe error remains consistent at different positions of the comparative caliper, the zeroing compensates for the Abbe error in all subsequent measurement, enhancing accuracy across various measurement points.

The Chinese Patent 202311514032.9 describes a comparative measurement caliper that allows the user to set multiple reference values and tolerance ranges. In the disclosure, a plurality of groups of the reference values and tolerance limits are configured as follows:

The user operates the input device 102 to enter the setup mode. Each group of reference value and tolerance limits is set in sequence.

After setting one group of the reference value and tolerance limits, the user can save and exit the setup mode or continue to set the next group of the reference value and tolerance limits. The comparative caliper allows the user to store N groups of the reference values and tolerance limits. For instance, N is set to 9. When performing a measurement, the comparative caliper automatically identifies a correct group of the reference value and tolerance limits for the measurement point. The identification process works as follows: When the comparative caliper takes a measurement, the reading is recorded as a measurement value x. Additionally, the absolute value of the measurement is recorded as a. Each reference value is assigned with a unique identifier n, and each reference value is denoted x(n). The signal processing module identifies which reference value to use, and calculates an absolute difference |a−x(n)| between the measurement absolute value a and the identified reference value. The signal processing module loops through all the reference values n and finds one reference value that gives the smallest absolute difference |a−x(n)|. The identifier n of the identified reference value is recorded. The signal processing module retrieves the corresponding reference value and tolerance limits from the memory. The corresponding reference value and tolerance limits are displayed on the display device for the user to see. The signal processing module compares the measurement value x with the corresponding reference value x(n) and check if the difference falls within an acceptable tolerance range. Specifically, the measurement value x is marked as “qualified” if the measurement value x is less than or equal to the sum of the identified reference value x(n) and the upper tolerance limit, and is greater than or equal to the sum of the identified reference value x(n) and the lower tolerance limit. Otherwise, the current measurement value x is marked as “unqualified”. The identification process simplifies the measurement process by allowing users to measure any group of the reference values in any order without having to memorize or select specific settings manually. By automating both the group identification and Abbe error compensation, the comparative caliper enhances measurement efficiency and accuracy.

### EXAMPLE 2

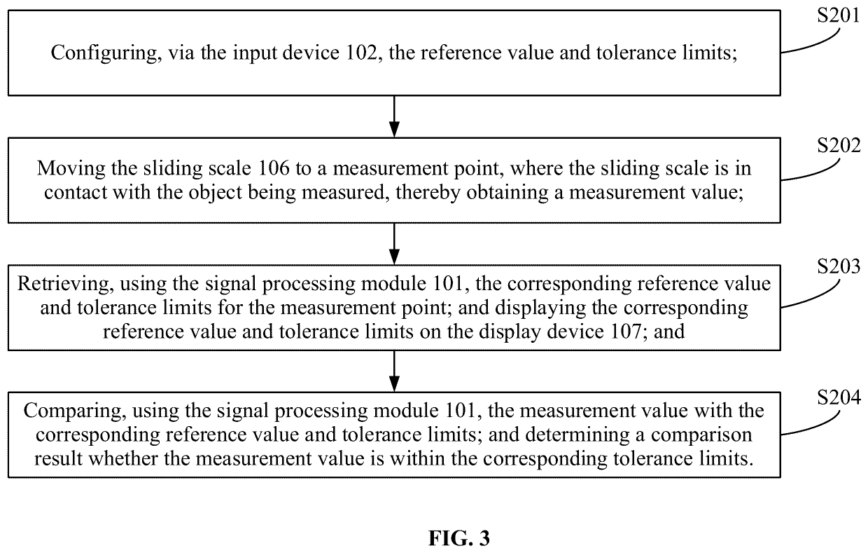

FIG. 3 is a flowchart of the steps in a method for measuring the comparative caliper according to Example 2 of the disclosure. As shown in FIG. 3, the disclosure provides a method for measuring the comparative caliper, the method comprises:

S201. configuring, via the input device 102, the reference value and tolerance limits;

S202. moving the sliding scale 106 to a measurement point, where the sliding scale is in contact with the object being measured, thereby obtaining a measurement value;

S203. retrieving, using the signal processing module 101, the reference value and tolerance limits for the measurement point; and displaying the reference value and tolerance limits on the display device 107; and

S204. comparing, using the signal processing module 101, the measurement value with the corresponding reference value and tolerance limits; and determining, using the signal processing module 101, a comparison result whether the measurement value is within the tolerance limits.

Specifically, the user operates the input device 102 to enter the setup mode. In the setup mode, each group of reference value and tolerance limits is sequentially set.

Specifically, after completing one group of the reference value and tolerance limits, the user can save and exit the setup mode or continue to set the next group of the reference value and tolerance limits. The comparative caliper allows the user to store N groups of the reference value and tolerance limits. When performing a measurement, the comparative caliper automatically identifies a correct group of the reference value and tolerance limits for the measurement point. The identification process works as follows: when in comparative measurement mode, the signal processing module 101 automatically calculates the difference between the measurement value and the corresponding reference value. The signal processing module 101 loops through all the reference values and finds one reference value that gives the smallest absolute difference, and then retrieves the corresponding reference value and tolerance limits. The retrieved reference value and tolerance limits are displayed on the display device 107. The identification process simplifies the measurement process by allowing users to measure any group of the reference values in any order without having to memorize or select specific settings manually. By automating both the group identification and Abbe error compensation, the comparative caliper enhances measurement efficiency and accuracy.

It will be obvious to those skilled in the art that changes and modifications may be made, and therefore, the aim in the appended claims is to cover all such changes and modifications.

What is claimed is:

1. A comparative caliper, comprising:
a signal processing module;
an input device; and
a measurement device;
wherein,
the signal processing module is connected to the input device and the measurement device; the input device is configured to set a reference value and tolerance limits; the measurement device is configured to measure a relative displacement between two points on an object, and then relays the relative displacement to the signal processing module; and the signal processing module is configured to store data and perform calculations.

2. The comparative caliper of claim 1, wherein the signal processing module comprises a memory and a microcontroller; the microcontroller is connected to the input device and the measurement device; the memory is connected to the microcontroller; the measurement device comprises a capacitive grating sensor; the microcontroller is configured to process signals received from the capacitive grating sensor; and the memory is configured to temporarily storage data during a calculation process and stores a final calculation result.

3. The comparative caliper of claim 2, wherein the measurement device further comprises a fixed scale and a sliding scale; the capacitive grating sensor is disposed on the fixed scale and the sliding scale; the capacitive grating sensor is connected to the microcontroller; the capacitive grating sensor is configured to detect the relative displacement between the fixed scale and the sliding scale, and then relays the relative displacement to the signal processing module; the capacitive grating sensor is further configured to set characters for the reference value and tolerance limits, and then transmits the characters to the memory.

4. The comparative caliper of claim 1, wherein the comparative caliper further comprises a display device connected to the signal processing module; and the display device is configured to display the relative displacement, the tolerance limits, the reference value, and a comparative judgement result.

5. A method for measuring using the comparative caliper of claim 1, the method comprises:
configuring, via the input device, the reference value and tolerance limits;
moving a sliding scale of the measurement device to a measurement point, where the sliding scale is in contact with the object being measured, thereby obtaining a measurement value;
retrieving, using the signal processing module, the reference value and tolerance limits for the measurement point; and displaying the reference value and tolerance limits on the display device; and
comparing, using the signal processing module, the measurement value with the reference value and tolerance limits; and determining, using the signal processing module, a comparison result whether the measurement value is within the tolerance limits.
